(19) United States
(12) Patent Application Publication
(10) Pub. No.: US 2011/0213658 A1
(43) Pub. Date: Sep. 1, 2011

(54) BANKING CENTER COMMUNITY DISPLAY

(75) Inventors: David Joa, Irvine, CA (US); Kurt D. Newman, Matthews, NC (US); Timothy James Mark, Berkeley, CA (US); Srinath Nagarajan, Waltham, MA (US)

(73) Assignee: BANK OF AMERICA CORPORATION, Charlotte, NC (US)

(21) Appl. No.: 12/713,899

(22) Filed: Feb. 26, 2010

(51) Int. Cl. G06Q 40/00; G06Q 30/00

(52) U.S. Cl. 705/14.52; 705/35; 705/14.58; 705/43

(57) ABSTRACT

Embodiments of the present invention provide a system, method and computer program product for providing a new bank-based communication system. For example, embodiments of the invention provide a method for: (1) identifying a user interface, where the user interface is associated with a banking center accessible to a user; (2) identifying a banking center community associated with the banking center; (3) determining content to present on the user interface based at least partially on the banking center community; and (4) presenting the content to the user using the user interface.

### FIELD

Embodiments of the invention relate generally to communication systems and methods.

### BACKGROUND

With increased demand for lower costs and improved customer service, banks continue to grow in size. Today's large national and international banks have many advantages compared to small banks. Perhaps the most obvious advantage to banking with a large national or international bank is the stability of the bank and, thereby, the safety of a customer's money and confidential information. Due to their size and the amount of capital that they manage, large banks can usually withstand negative economic events better than many small banks. Large banks also have many internal rules, regulations, and systems in place to prevent and identify fraud both from persons internal and external to the bank. Other advantages may include lower fees and/or higher interest rates for customers due to the larger bank's economies of scale. Customer service at a large bank may also be better in many respects. For example, a customer of a large bank may be able to find an automated teller machine (ATM), bank branch, or other banking center within a few minutes of most locations in the country or world frequented by the customer. In this way, customers of large banks can often access their finances more easily from anywhere in the world and at any time of day compared to customers of small banks. Furthermore, transactions may be handled by a larger bank more quickly and with fewer errors than a smaller bank. Large banks also traditionally offer a greater variety of financial products and services to their customers.

One potential downside to some large banks is a movement away from the feeling of a local community bank. As a result of the trends towards larger banks, banks are less likely to be places within a community where individual customers and business customers interact with each other and the bank employees on a regular basis. Furthermore, when banks do participate in local community events or charities they often are not widely recognized by their customers unless the customers are directly involved in the events or charities.

Therefore, there is a need to develop apparatuses and methods that help larger banks to provide its customers with a more local banking experience focused on the communities in which these customers live, work, and do business.

### BRIEF SUMMARY

Embodiments of the present invention address the above needs and/or achieve other advantages by providing an apparatus (e.g., a system, computer program product, and/or other device) and method for providing a banking center community display system. The banking center community display system provides user interfaces (e.g., electronic bulletin boards) in banking centers located in a plurality of different local communities. The banking center community display system then uses these user interfaces to present information relevant to the local communities and the people that make up the local communities. In one embodiment, the banking center community display system automatically determines what information to provide to each user interface based at least partially on the banking center in which the user interface is located and a local community associated with the banking center.

For example, in accordance with an aspect of the present invention, a method for providing a banking center community display includes determining a location of a banking center. The location of the banking is used to determine the banking center community that is appropriate for the banking center. For example, a banking center may be located in a town and therefore, in one embodiment, the banking center community may be defined by the town boundaries. The bank determines appropriate content for presentation in the banking center community. For example, the bank may determine that a message relating to the bank's support of a local nonprofit would be of interest to the banking center community. The bank also presents the content through banking centers in that community, for example, through electronic bulletin boards located in the lobbies of bank branches and/or through billboards located on the exterior of the bank branches or attached to the bank's automated teller machines (ATMs). In some embodiments, the content presented through the presentation devices at all of the different banking centers is centrally and remotely controlled by a central local information distribution center maintained by the bank. Such a banking center community display system provides local information targeted to the community in which the content is being accessed as well as, in some cases, targeted to the particular user(s) of the community display.

Other aspects and features of the present invention, as defined by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 is a flow chart of a high level schematic of a method for a banking center community display in accordance with some embodiments;

FIG. 2 is a flow chart of a method for a banking center community display in accordance with some embodiments;

FIG. 3 is a schematic of the relationships between the components of the banking center community display system in accordance with some embodiments;

FIG. 4 is a block schematic diagram of an example system for a banking center community display system in accordance with some embodiments; and

FIG. 5 is an example of a graphical user interface for a banking center community display in accordance with some embodiments.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described below with reference to flowchart illustrations and/or block diagrams of such methods and apparatuses. It will be understood that each block of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wireline, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment, an entirely software embodiment (including firmware, resident software, micro-code, etc.) or an embodiment combining software and hardware aspects that may generally be referred to herein as a “module,” “application,” or “system.”

It should be understood that terms like “bank,” “financial institution,” and just “institution” are used herein in their broadest sense. Institutions, organizations, or even individuals that process financial transactions are widely varied in their organization and structure. Terms like financial institution are intended to encompass all such possibilities, including but not limited to, banks, finance companies, stock brokerages, credit unions, mortgage companies, insurance companies, etc. Additionally, disclosed embodiments may suggest or illustrate the use of agencies or contractors external to the financial institution to perform some of the calculations and data delivery services. These illustrations are examples only, and an institution or business can implement the entire invention on their own computer systems or even a single work station if appropriate databases are present and can be accessed.

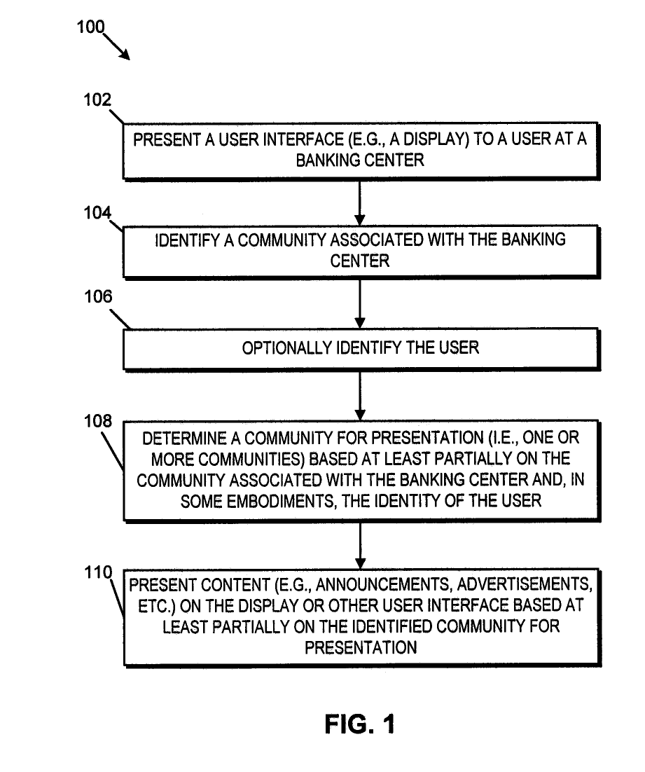

As illustrated in FIGS. 1-5, embodiments of the present invention include methods, systems and computer program products directed to a banking center community display. In an embodiment, a banking center community display relates to a user interface associated with a banking center presenting content associated with the community of the banking center. The content is determined based at least in part on the banking center community and optionally the user community. Accordingly, the banking center community display provides relevant community information targeted to both the local community of the banking center and, in some embodiments, to the user of the user interface. Creation, management, and presentation of the banking center community display are discussed in more depth below with regard to FIGS. 1-5.

FIG. 1 is a high-level schematic of an example of a method 100 for a banking center community display in accordance with an embodiment of the present invention. In block 102, a provider of the banking center community display system presents a display or other user interface to a user at a banking center. In block 104, the provider of the banking center community display system identifies a community associated with the banking center. In block 106, the provider of the banking center community display system may optionally identify the user. In block 108, the banking center community display system determines one or more communities for presentation based at least partially on the community associated with the banking center and, in some cases, on the identity of the user. In block 110, the banking center community display system presents content on the display or other user interface based at least partially on the identified community for presentation.

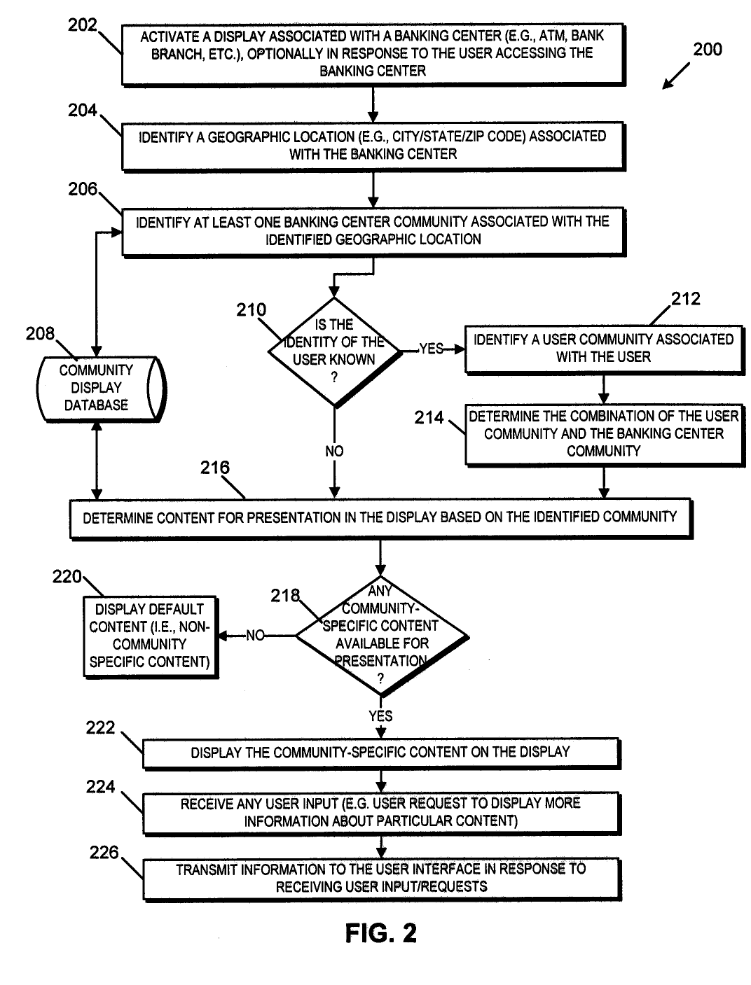

FIG. 2 is a flowchart of an example of a method 200 for a banking center community display system in accordance with an embodiment of the present invention. In block 202, the provider of the banking center community display activates a display and/or other user interface associated with a banking center. In some embodiments of the invention, the provider is the bank that maintains the banking center, such as a national or international bank that maintains numerous banking centers (e.g., ATMs and bank branches) around a particular country or the world. In other embodiments, the provider is a third party that has access to the bank's information or some other third party.

In some embodiments, the provider activates the display and/or other user interface in response to a user accessing the banking center. For example, in some embodiments, the banking center community display system automatically activates the display or other user interface based on detection of a user. The user may be detected, for example, by motion detectors located proximate to the display/user interface, by the user interacting with the display/user interface, or with other devices communicably coupled to the display/user interface. The user may be, for example, a bank customer, a potential bank customer, or a person associated with a current bank customer. In another example, the user may be a non-human entity such as a corporation, small business, or nonprofit.

In some embodiments of the invention, the display/user interface is activated based on a regular schedule. In still yet another embodiment, the user interface or display/user interface is activated electronically, remotely, or in-person by, for example, a bank employee or a remote community display management server.

The user interface may include a graphical user interface (GUI), an audio device, a display device, a tactile device, and/or any other device that allows a user to receive and, in some cases, respond to content delivered through the user interface. In some examples, the user interface is a display such as an electronic bulletin board located in the lobby of a bank branch, a billboard located on the exterior of a bank branch or proximate to an ATM, an ATM screen, and/or the like. In some embodiments, the display/user interface includes a speaker, a touch sensitive screen, a keypad, a touch pad, a keyboard, a pointing device, a motion detector, and/or the like. It should be understood that the examples of displays and other user interfaces generally do not limit the types of displays, user interfaces, or other types of content presentation devices that may be used in other embodiments of the banking center community display system.

In some embodiments of the invention, the banking center of block 202 is a building, room, or other physical structure associated with the bank, such as, for example, a bank branch where bank customers and potential customers go to meet with bank employees, use bank-owned facilities, and/or conduct other financial business with the bank. In some embodiments, the banking center is an electronic device associated with the bank such as an ATM, a kiosk, a computer, an electronic bulletin board associated with the bank and placed within a bank branch or affiliate, or any other device associated with the bank. Examples of user interfaces associated with a banking center include an ATM screen, a touch sensitive electronic bulletin board in a bank lobby, a graphical user interface associated with the banking center, and/or the like. It should be understood that other banking centers may be apparent to one of ordinary skill in the art in view of this disclosure.

As described above, a particular community is associated with the banking center and is identified by the provider of the community display system. In one embodiment of the invention, as presented by blocks 204 and 206, the banking center is associated with a particular community by virtue of its location, and the banking center community display system determines the banking center's community by first determining the banking center's geographic location and then determining the community associated with that geographic location. In other embodiments, however, each banking center itself has a particular community of individuals with which it is associated that is not based on geographic location alone. Such a community of individuals may be based on geography but may or may not correspond with a particular geographic identifier, such as zip code boundaries, town boundaries, city boundaries, county boundaries, state boundaries, area code boundaries, and/or the like. For example, in one embodiment, the community for a particular banking center is defined by customers that frequent the banking center and/or the location of these customers. Such a community may be dynamic and determined automatically by the banking center community display system.

Referring again to block 204, in the illustrated embodiment of FIG. 2, the banking center community display system identifies a geographic location associated with the banking center. For example, geographic location may be represented by a street address, city, state, county, region, metropolitan area, zip code, area code, X and Y coordinate, latitude and longitude coordinate, GPS coordinate, location on a map, other geo-code, one or more of the above, combinations of the above, and/or any other mechanism for identifying the geographic location of the banking center. In some embodiments, the location of the banking center is known before activation of the display/user interface, such as with an ATM or bank branch device, and is accessible by accessing a database stored in a memory device. For example, in one embodiment, a memory device includes a database of all of the community display devices throughout the bank and has, associated with each display device, the name and/or location of the banking center at which the display device is located. This database or another database may list each banking center or each geographic identifier and have a community definition associated with each banking center or each geographic location. In an alternative embodiment, the location of the banking center is determined at the time of activation of the display. For example, a display located at an ATM may have its location stored in its or the ATM's local memory device and this location may then be communicated to a remote community display management server when the display is activated.

Referring to block 206, in the illustrated embodiment where the banking center community display system identifies a geographic location associated with the banking center, the banking center community display system identifies the banking center community associated with the identified location. In one embodiment, the banking center community is a geographic area with which the banking center is associated. For example, the banking center community may be the community defined by the country, state, county, municipality (e.g., city, town, village, etc.), electoral district, metropolitan area, facility, or ZIP code in which the banking center is located. In other examples, the banking center community is the geographic area in which some or all of the banking center's customers are located, a predetermined geographic area defined by the bank that may be within or cross municipal boundaries, or an area defined by a predetermined radius or driving distance/time from the banking center.

In some embodiments, a banking center may, at least initially, have more than one banking center community associated with it. In some such embodiments where a banking center has more than one appropriate banking center community, such as both a state and a town, the banking center community display system may determine one appropriate community or may appropriately combine the content associated with each community as described in greater detail below. For example, the banking center community display system may determine the appropriate banking center community based on the relative size of the communities, the number of bank customers in each community, the content associated with each community, the smallest or most local community for which content is available, or based on any other criteria or rules for determining the community or community/content priority. In another embodiment, the appropriate community may be determined based on the user. For example, if a user is known to reside within the banking center's state but not within the banking center's town, the community display system may determine that the banking center community, for purposes of this user, is the state rather than the town. It should be understood that a banking center may have multiple communities that may be nested within one another such as a zip code nested within a county nested within a state.

In some embodiments of the procedure illustrated by block 206, the banking center community is a group of individuals or businesses with which the banking center is associated. For example, the banking center community may be all of the individuals that have an account or opened an account at the bank branch, all of the individuals whose mailing address is in the same ZIP code as the banking center, all of the bank customers in a predefined proximity to the banking center, all business customers of the banking center, and/or the like.

In another example, if the banking center is located at a facility owned or used by a certain group of individuals, then the community may be this group of individuals. For example, if the banking center is located within or proximate to a particular college campus, the community for that banking center may be defined as all students that attend that college or all bank customers that are associated with that college (e.g., association may be determined from transactions made with college related business, student loan data, account opening data, customer-provided information, customer bank card having college logo, and/or any other customer information available to the bank). In another example, the banking center community display system may determine that the community for a banking center located within a stadium may be fans of the team that plays in the stadium. In some embodiments, the banking center community display system may even be configured to determine community based at least partially on the banking center and based at least partially on the date or time. For example, in the stadium banking center example, the banking center community display system may have stored in its memory a schedule of events occurring at the stadium and may change the community for that banking center based on the event occurring on a particular day or time (e.g., define the community as fans of a particular team when that team is playing at the stadium and define the community as fans of a music group when that music group is playing at the stadium).

The banking center community may be constant or may change over time. For example, the banking center community may change because of changing customer demographics, changing political boundaries, changing bank pre-defined boundaries, changing location of the banking center, and/or changing content. A banking center may have multiple communities that do not overlap as well. For example, the banking center may have a geographic community based on its physical location and a customer community based on customers that reside or conduct business near that location and the two communities may or may not overlap.

Referring now to block 208, in some embodiments of the invention, the banking center community display system includes a community display database. In some such embodiments, the community display database stores information associated with banking center communities. For example, the community display database may include a community definition (which may be, for example, a geographic boundary or other geographic area description, a customer list or other customer group description, one or more community determining rules, one or more schedules, and/or the like) associated with each banking center or each geographic location or group of locations. In some embodiments, the community display database includes the content associated with each community and/or other information used to provide the banking center community display system described herein.

In decision block 210, in some embodiments of the invention, the provider of the banking center community display determines whether the identity of the user is known. In some instances, the identity of the user is not known and the method for providing a banking center community display 200 is accomplished without regard to the user. For example, an electronic bulletin board in a bank lobby may have no mechanism for identifying the viewer of the bulletin board and may present content based, in some instances, only on the community associated with the banking center. In other instances, the identity of the user is known to the banking center community display system. For example, the user of a community display that is associated with a particular ATM may use a bank card and PIN to log into the ATM associated with the display. The ATM system may then communicate the user's identity to the banking center community display system which then uses this information, in conjunction with the ATM's community information, to determine which content to present at the community display. In another example, an electronic billboard in a bank branch lobby may have a sensor for reading a nearby user's bank card or other transaction device (such as a cell phone with near-field communication capabilities that enable the phone to work as the user's bank card). In another example, the an electronic billboard located in the bank lobby may guess the identities of at least some of the customers in the lobby within a particular period of time by virtue of the customers interacting with tellers or automated tellers to complete financial transactions within this period of time. The electronic billboard may then present content based on communities associated with these customers. In still other embodiments, the banking center community display system includes one or more biometric sensors and can identify the user by biometrics, such as, for example, fingerprint, facial recognition, iris scan, and/or the like. In some embodiments, the banking center community display identifies the user by the user's secure logins (e.g., username and/or passwords), electronic identifiers (e.g., electronic key fobs), or other devices such as bank cards or bar codes. In some embodiments, the identity of the user is known before the banking center community display is activated. In another embodiment, the identity of the user is determined after the banking center community display is activated.

Turning now to block 212, in some embodiments of the invention where the identity of a user can be determined, the banking center community display system identifies the community or communities associated with the user. In some embodiments, the user community is a geographic region associated with the user. For example, the region may be a country, state, county, ZIP code, municipality, electoral district, metropolitan region, and/or the like associated with the user (e.g., located in the user's home and/or work address). In another embodiment, the user community is defined by the bank or by the user. For example, the bank may determine the user community based on transaction data associated with the user's bank account(s), such as data showing that a user resides in a region, frequently conducts business in a region, associates with people or businesses in a region, or is in some other way associated with a region. In still another embodiment, the user defines his user community by, for example, selecting a specific region such as the state in which he resides or the county in which he has a vacation home. As previously stated, in some embodiments a user has more than one user community. The user community may be predetermined or determined when the banking center community display is activated. For example, the user community may be determined based on the current location of the user when a smart-phone application is activated or when the user logs into an ATM. Also, in some embodiments, the user may change his user community. In some embodiments of the invention, information associated with the user communities is stored in the community display database 208, as previously described.

In some embodiments of block 212, the user community is a group of individuals or businesses with which the user is associated. In an embodiment, the user defines his community of individuals or businesses for which he is interested in receiving content. In another embodiment, the bank determines the user community based on bank-specific data. For example, the user community may be all of the businesses with which the user has done business based on transactions associated with the user's bank account, the user community may be all of the individuals that are associated with the user on a social networking site, the user community may be all of the family members of the user, or any other group of individuals or businesses that can be identified by the bank or defined by the user as associated with the user.

In block 214, in some embodiments of the invention where a user community is determined, the banking center community display system determines the community for the display or other user interface based on a combination of the user community and the banking center community. For example, the user community and the banking center community may be identical, may overlap, or may not overlap. The user community and banking center community may be identical if, for example, the user lives in the same community that the banking center is located within. In another example, the user community and banking center community may overlap if one completely encompasses the other such as when a user community is a county and a banking center community is a town completely within that county. Alternatively, a user community and banking center community may partially overlap so that there is an area in common and areas that do not overlap. For example, a user community may be a metropolitan region that spans two states and a banking center community may be one of the states such that there is an area of overlap where the metropolitan region is within the state. In such an embodiment, the banking center community display system may determine that the community is where the user and banking center communities overlap or it may determine that the community is the union (e.g., sum) of the user and banking communities. In another embodiment, the user community and banking center community do not overlap. For example, a user community may be a state where the user resides and a banking center community may be a different state where the user is accessing an ATM. In some such embodiments, the banking center community display system selects one of the two communities based on predefined priority rules, content available for each community, and/or other factors. In still other such embodiments, the banking center community display system determines that the community is the sum of the user and banking center communities or, instead, uses a generic or default community. In a further embodiment, the user community and banking center community are overlapping or non-overlapping groups of individuals or businesses. For example, the user community may be all of the individuals that have made purchases at the same grocery stores as the user and the banking center community may be all of the individuals that are customers of the bank and reside a predetermined distance from the banking center. In yet another embodiment, the user community and banking center community may be a combination of overlapping and non-overlapping geographic communities and groups of individuals or business defining a community.

In block 216, the provider of the banking center community display determines content for presentation through the display/user interface based at least partially on the identified community. Content is any information that can be presented to as user using a display or other user interface. Content may be visual, auditory, tactile, olfactory, gustatory, or some combination of the above. In some embodiments, content is a communication from the bank. In other embodiments, content is a communication from a bank customer, a non-bank associated individual or group, a governmental entity, a bank business customer, a local business or other business, and/or the like. For example, content may be an advertisement, a notice, an announcement, a message, or any other sort of communication. For example, the content may be an advertisement for a sale that a bank customer is having and desires to target to one or more particular communities. In other examples, the content may be a message from the bank about the bank's involvement in the particular community or the content may be a public service announcement from the local government.

In some embodiments of the invention, the banking center community display system includes a bank-based advertising system and is configured to present advertisements created using the bank-based advertising system where the advertisements may be targeted to one or more particular communities. U.S. patent application Ser. No. ______ to Joa et al., entitled “Bank Based Advertising System,” and filed concurrently herewith, describes such a bank-based advertising system in greater detail and is hereby incorporated by reference in its entirety. For example, in one embodiment, a business customer of the bank can use the bank's authentication procedures to log into a bank-based advertising system (thereby identifying himself/herself as having the authority to create advertisements for a business associated with a particular business account) and use an advertising tool to create/upload advertising content and select target communities for the advertisement. The banking center community display system may then display the advertisement in various banking centers based at least partially on the advertisement's target community/communities and each banking center's associated community/communities. In some embodiments, the bank charges fees to the advertiser based on the distribution of the advertisement and, in some cases, the bank reinvests these fees into the local community.

As previously discussed and illustrated in block 208, some embodiments of the banking center community display system include a community display database. Content may be stored in such a community display database. For example, the community display database may include any stored information relating to content, banking centers, user interfaces, banking center communities, user communities, and user preferences. In some embodiments, the community display database is updated with new content on an ongoing basis as the bank receives the content. In another embodiment, the community display database is updated with new content by a customer authorized to input content. Other ways of updating the content stored in the community display database are possible, including by use of social networking data, publicly available information, agreements with bank affiliates, or other sources of data. For example, the community display database may be updated with content on a regular basis, as needed, on an ongoing basis, on a default schedule, on a predetermined schedule, or any other timeframe.

Turning back to block 216, content may be determined for the display or user interface using various methods. As described above, content is generally determined for display based at least partially on whether the content is appropriate for and/or relates to the banking center community. For example, an advertisement for a sale in the same town as a bank branch may be appropriate for presentation in the bank branch's community. In another example, a message from the bank about the bank's support of a local nonprofit may be appropriate for presentation on user interfaces or displays in the community where the nonprofit is active. Content may be appropriate for more than one banking center community. For example, an advertisement for a business may be appropriate for presentation in all user interfaces and displays at banking centers in the same metropolitan area as the business as well as for presentation to all users that have made a purchase at the business.

In another embodiment of block 216, content is determined based on both the banking center community and the user community. As previously discussed and illustrated in block 214, in some embodiments of the invention, the banking center community display system determines the combination of the user community and the banking center community. In some embodiments, the combination of the user community and the banking center community increases the content that is appropriate for presentation in the user interface or display. For example, a user community may have eight communications appropriate for presentation and a banking center community may have ten communications appropriate for presentation resulting in a pool of eighteen communications appropriate for presentation in a user interface. In another embodiment, the combination of a user community and banking center community influences the determination of the appropriate content. For example, a user community may have eight communications appropriate for presentation and a banking center community may have ten communications appropriate for presentation; if two of these communications are present in both the user community and banking center community there are only sixteen unique communications for presentation. In this example, the two communications that are present in both the user community and the banking center community may be presented preferentially over the remaining communications.

In some embodiments of block 216, content is determined based on the banking center community and the date of the content. In some instances, content may have a date that is available for presentation and an expiration date. For example, content may be selected from a plurality of content appropriate for the banking center community based on the availability or expiration date of each content. In some embodiments, the communication that will expire soonest may be presented in the user interface first. Alternatively, the communication that is most recently available for presentation may be preferentially presented. It should be understood that content may have more than just an availability and expiration date, and that other dates may also be relevant to whether content should be presented on a user interface at any given time. For example, an advertisement for a sale may be available one week before the sale begins through the end of the three-day sale. The day the sale begins may also be an important date for the presentation of the content and may therefore influence its presentation frequency. Other ways in which the dates associated with content influence the presentation of the content are possible.

In some embodiments of block 216, content is determined based on a banking center community and the identity of the user. The bank may have bank-specific data indicating that content is appropriate for the user of the user interface and use this to determine priority for presenting different content associated with the banking center. For example, a bank may identify a user of an ATM, determine that the user donated money to a nonprofit based on transactions in a user's bank account, and select a communication regarding the bank's involvement with the nonprofit for presentation to the user from a plurality of communications appropriate for the ATM's banking center community. In another example, content may be appropriate for a user if the user's bank accounts indicate that the user has a high net worth, a small net worth, is a business owner, or any other classification that would influence the determination of which content is appropriate for presentation.

In yet another embodiment of block 216, content is determined based on the banking center community and user-defined criteria. For example, user-defined criteria may be defined explicitly, such as when a user indicates that he is interested in all content related to a given bank customer, or implicitly, such as when a customer indicates that he does not want the bank to use his personal transaction data to personalize content for him. In an embodiment, user-defined criteria are defined by the user and stored in the community display database.

It should be understood that the aforementioned embodiments of block 216 are not limiting. Other methods of determining content based on the banking center community and/or user community are possible and within the scope of the current disclosure. For example, content may be determined for presentation randomly, sequentially, based on user input, or any other mechanism based on the banking center community, the user community, user input, date, time, and/or one or more predefined rules.

Moving now to decision block 218, in some embodiments the content is evaluated to determine whether the content is unexpired and available for presentation. Content is unexpired if the last day that the content is available for presentation is not passed. Content is available for presentation if the banking center community display system determines that there is no reason to prevent the content from being presented. In an embodiment, reasons why content is not be available for presentation include that the content is expired, that the content has not been approved by the bank for presentation, that the content violates default or pre-defined bank rules, or that the content violates government regulations. In some embodiments, if no content is available for presentation, the process may end and content is not presented on the user interface or display, as illustrated in block 220. If at least one piece of content is available for presentation the banking center community display presents the content. In still other embodiments, if no content is available for presentation, the banking center community display system presents default content, such as a bank advertisement or other notice. In still other embodiments, if not content is available in the community for the banking center's community and any user community, the banking center community display system may identify the most similar one or more communities to that of the banking center and use content associated with these communities.

In block 222, content is presented on the display or other user interface. In an embodiment, content is presented visually, audibly, tactilely, and/or in other ways. Content may be presented continuously, intermittently, upon a triggering event, or at any other frequency appropriate for presentation. For example, visual content may be continuously presented through an electronic bulletin board in a bank lobby. In another example, audible content may be presented at an ATM when a user logs into the ATM and triggers the presentation.

Turning now to block 224, in some embodiments the banking center community display system receives user input or requests through, for example, the user interface. For example, the banking center community display system may receive user input or requests through a touch sensitive screen, a voice command, use of a keypad, use of a keyboard, or other mechanisms for inputting information. In another embodiment, user input includes an indication to change the content to a new content, an indication to change the user community or criteria, an indication of approval or disapproval of the content, a request for more information regarding the content, a desire to enroll in a program described in the content, or any other input appropriate for a banking center community display. For example, a user viewing a sale advertisement on an electronic bulletin board may be able to use the touch sensitive screen to request a map to the sale location. In another example, a user viewing a bank communication regarding the bank's involvement with a nonprofit in the local community may be able to donate money to the nonprofit by interacting with the user interface. In a further example, a user viewing a business advertisement may input a request that the business be added to his user community so that he will receive future content related to the business.

Turning now to block 226, the provider of the banking center community display system transmits information to the user interface in response to receiving the user input and/or requests. The information may be transmitted wirelessly, over a network, over the phone lines, through the mail system, or by other means of providing information to a user or user interface. The information may be transmitted immediately or at a later date. In an embodiment, the information transmitted is a response to a question posed by the user. For example, a user may request more information about the bank's involvement with a local organization after seeing content related to that involvement. The information may be e-mailed, mailed, delivered via a phone call, or provided immediately on the user interface. Other examples include providing a map to a location such as a business discussed in the content, providing a phone number, mailing information to a user in response to the user's request, or other methods of transmitting information to the user or user interface. In another embodiment, the information transmitted is new content in response to the user requesting new content or the user's actions indicating that new content is appropriate.

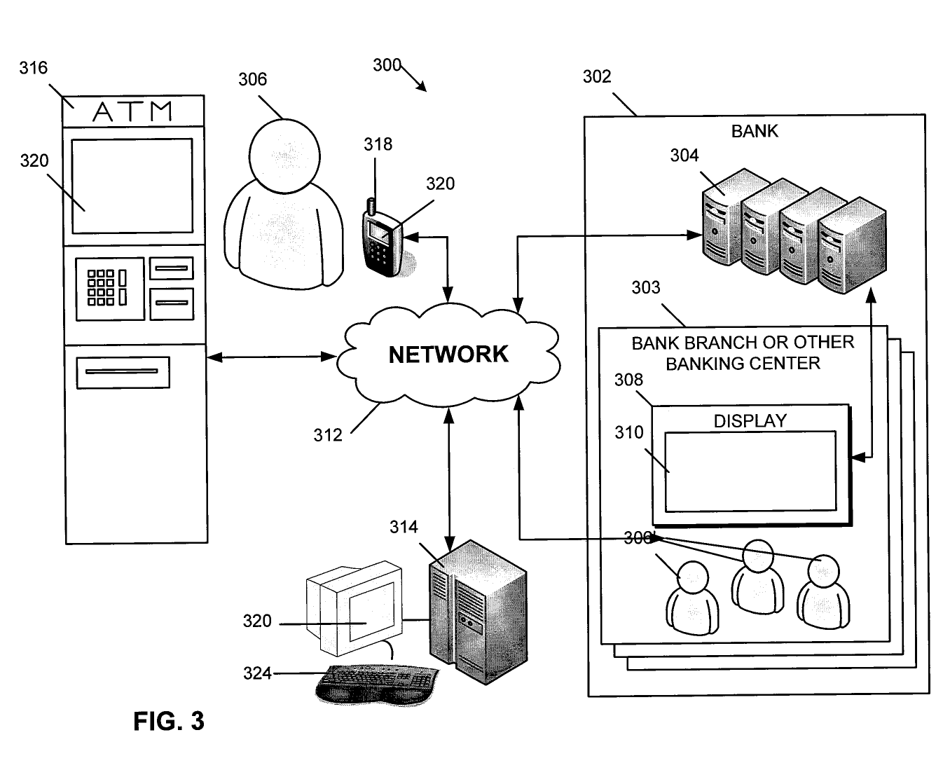

FIG. 3 is a schematic diagram of an example of a banking center community display system 300 in accordance with an embodiment of the present invention. In an embodiment, the system 300 includes a bank 302, a server 304, a plurality of bank branches or other banking centers 303, and a user 306 or users 306′. The bank 302 may store the server 304 at a bank branch, bank headquarters, other bank facility, or a non-bank facility. In one embodiment, the bank includes numerous bank branches and/or other banking centers and the server 304 is located remote from most of these banking centers.

In some embodiments, the server 304 includes the community display database and provides content to a variety of displays and other user interfaces in the plurality of banking centers 303. For example, the server 304 may provide content to a display 308 at a particular bank branch 302 either directly or over a network 312. In another embodiment, the display 308 includes a touch sensitive screen 310 that allows the banking center community display system to present the content on the display and receive any user input or requests from the users 306′. The bank 302 may also provide content from the server 304 over the network 312 to other user interfaces at other banking centers, such as other bank branches 303, a computer 314, an ATM 316, or a smartphone 318. In various embodiments, each of the computer 314, ATM 316, and smartphone 318 has a content presentation device like a monitor 320 and a communication interface 324 (comprising, in some embodiments, a user input/output device) for interacting with the banking center community display server 304. It should be understood that the banking center community display system 300 may include any number of components or additional components not listed herein, and the previously mentioned examples and embodiments are not intended to limit the banking center community display.

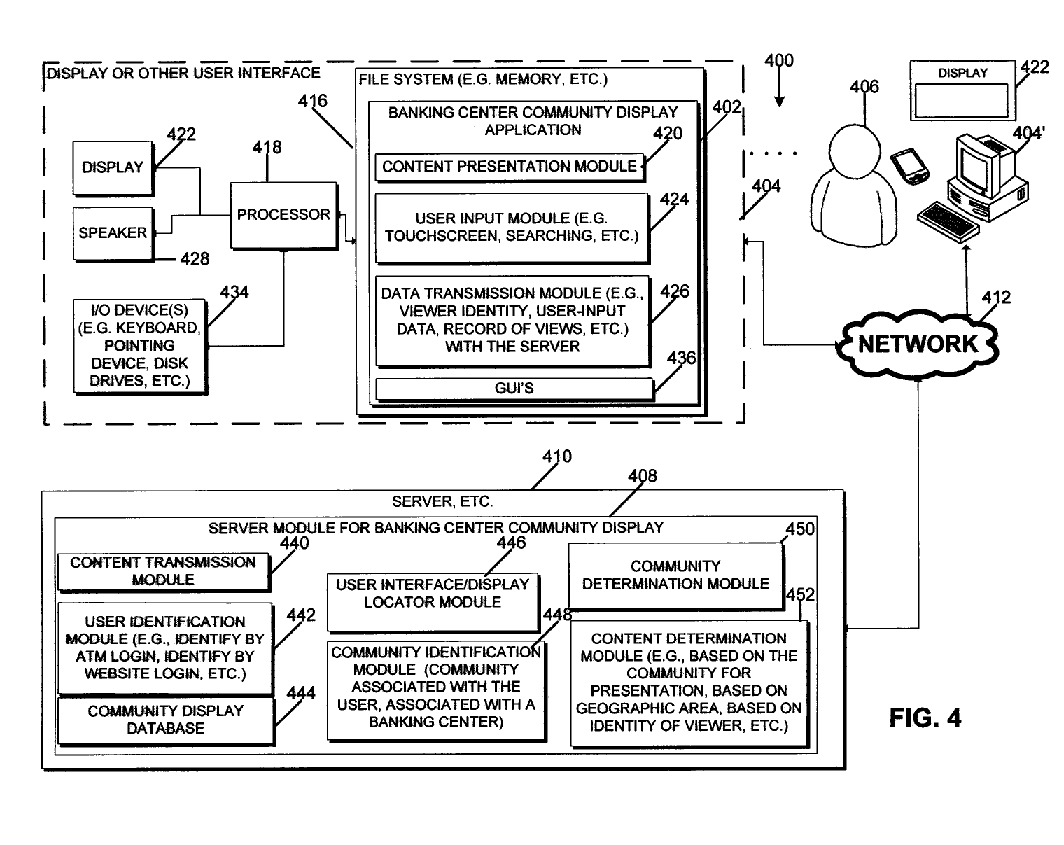

FIG. 4 is a block schematic diagram of an example of a banking center community display system 400 providing an additional level of detail, in accordance with an embodiment of the present invention. The banking center community display system 400 includes a banking center community display application 402 operable on a user interface 404 or similar device of a user 406 or a client 404′. In addition to the banking center community display application 402 on the user interface 404 or client 404′, the system 400 includes a banking center community display server application 408 operable on a server 410 and accessible by the user 406 or client 404′ via a network 412. The methods described herein are embodied or performed by the banking center community display application 402 and/or the banking center community display server application 408. For example, the methods may be performed by the banking center community display application 402. In another embodiment of the invention, the method is performed by the banking center community display server application 408. In a further embodiment of the present invention, some of the features or functions of the method are performed by the banking center community display application 402 on the user interface 404 and other features or functions of the method are performed on the banking center community display server application 408.

The network 412 is the Internet, a private network or other network as previously mentioned. Each user interface 404′ is similar to the exemplary user interface 404 and associated components as illustrated in FIG. 4.

The banking center community display application 402 and/or server application 408 is a self contained system with imbedded logic, decision making, state based operations and other functions that operate a banking center community display product.

The banking center community display application 402 is stored on a file system 416 or memory of a computer system 404. The banking center community display application 402 may be accessed from the file system 416 and run on a processor 418 associated with the user interface 404.

The banking center community display application 402 includes a content presentation module 420. The content presentation module 420 presents content such as advertisements, communications, notices, and messages on a user interface or display. In some embodiments, the content presentation module 420 is accessed or activated whenever the user interface or display 422 is activated or turned on. For example, the content presentation module 420 may be activated when a user 406 logs into an ATM or when a display 422 is turned on in a bank lobby.

In an embodiment, the banking center community display application 402 also includes a user input module 424. The user input module 424 allows the banking center community display server application 408 to receive information from the user 406. The user input module 424 receives information from the user 406 by an input device such as a keyboard or touch sensitive screen. This information can be an indication to change the content, an indication to change the user community or user criteria, an indication to receive more information regarding the content, or other information related to the functioning of the banking center community display. The user input module also allows the banking center community display server application 408 on the server 410 to transmit back to the user 406 a response to the user input.

The banking center community display application 402 also includes a data transmission module 426. At this point, the input of user information is transmitted to and/or received from the banking center community display server application 408 on the server 410 via the network 412. The transmission of data can be accomplished via a computer network, phone lines, wireless networks, and the like.

In an embodiment, the user interface 404 includes a display 422. Any graphical user interfaces 436 associated with the banking center community display server application 408 is presented on the display 422. In another embodiment, the user interface 404 also includes a speaker 428 for presentation of audio content. In yet another embodiment, the user interface 404 also includes one or more input devices, output devices, or combination input and output devices, collectively I/O devices 434. For example, the I/O devices 434 may include a keyboard, computer pointing device, touch screen, touch pad, or similar devices to control input of information as described herein. The I/O devices 434 also include disk drives or devices for reading computer media including computer readable or computer operable instructions.

In an embodiment, the banking center community display server application 408 includes a content transmission module 440. The content transmission module 440 performs functions related to receiving user input from the banking center community display application 402 on the user interface 404 and transmitting content back to the user interface or display for presentation. The user input and content is received and transmitted over the network 412.

The banking center community display server application 408 includes a user identification module 442 in some embodiments. The user identification module 442 receives information from the banking center community display application 402 on the user interface 404 to determine the identity of the user. For example, the user identification module 442 receives input from a user login at a website or through a user's bank card. The user identification module 442 communicates with other modules on the server 410, such as the community identification module 448 or the community display database 444.

In some embodiments, the banking center community display server application 408 also includes a community display database 444. The community display database 444 includes any stored information related to the banking center communities, user communities, user criteria, user identities, content, location of banking centers, and any other information associated with each banking center and user with regard to the banking center community display. The community display database 444 is used in connection with the content determination module 452 in the banking center community display server application 408.

In an embodiment, the banking center community display server application 408 includes a user interface/display locator module 446. The user interface/display locator module 446 operates when the location of a user interface and/or display is not known or stored in the database of community display data. The user interface/display locator module 446 interacts with the data transmission module 426 in the banking center community display application 402 on the user interface 404 to identify the location. The user interface/display locator module functions by connecting to other modules on the server 410, such as the community display database 444, to determine the location of the user interface to assist in determining the banking center community. For example, the user interface/display locator module 446 may locate the user interface or display based on a geographic positioning system (GPS) signal, geographic coordinates, in reference to a map, or in relation to a known geographic area or community. In an embodiment, the location is identified based on information transmitted from the banking center community display application 402 on the user interface 404. In another embodiment, information regarding the location is present in the community display database 444 on the banking center community display server application 408. Other means of identifying the location of the user interface are possible.

The banking center community display server application 408 also includes a community identification module 448. In an embodiment, the community identification module 448 identifies the banking center community and the user community when the communities are a geographic area. In another embodiment, the community identification module 448 identifies the banking center community and user community when the communities are a group of individuals. In a still further embodiment, the community identification module 448 identifies both the banking center community and the user community, including when they are defined by geography or defined by groups of individuals and businesses. The community identification module 448 operates by interacting with other modules on the server, such as the user interface/display locator module 446 and the community display database 444.

The banking center community display server application 408 includes a community determination module 450. The community determination module 450 determines the pool from which content will be selected. For example, the community determination module 450 may evaluate whether the banking center community and the user community overlap and the total extent of the community encompassed by both. In an embodiment, the community determination module 450 combines various types of communities, for example a banking center community of geographic scope and a user community composed of a group of individuals, so that content for presentation is selected from the content relating to both the banking center community and the user community. The community determination module 450 interacts with the content determination module 452 to select content for presentation from a plurality of content appropriate for the community.

The banking center community display server application 408 includes a content determination module 452. The content determination module 452 interacts with the community display database 444 and the community determination module 452 to identify content appropriate for the community and presents the content in a user interface or display. In an embodiment, the content determination module 452 evaluates the content and determines that content is appropriate for presentation based on geographic area, based on the banking center community and/or user community, based on the identity of the viewer, or based on other criteria relating to the content such as expiration date. The content determination module 452 interacts over the network 412 with the content presentation module 420 to present the selected content on a user interface or display 422.

The banking center community display application 402 includes graphical user interfaces 436, as previously mentioned. The banking center community display application 402 allows one or more predetermined graphical user interfaces 436 to be presented to the user 406 in order for the user 406 to input data or information into the system 400. The graphical user interfaces 436 are predetermined and/or presented in response to the user 406 indicating the user 406 would like to perform a task associated with the banking center community display, such as setting up display preferences, inputting content, inputting user criteria, inputting user communities, responding to content, presenting information to the user and financial institution, etc. The predetermined graphical user interfaces 436 are generated by the banking center community display application 402 and are presented on the display 422 at the user interface and/or display 404. Graphical user interfaces 436 also include graphical user interfaces that permit the user 406 to view the banking center community display and query any of the databases and/or generate reports and/or respond to content.

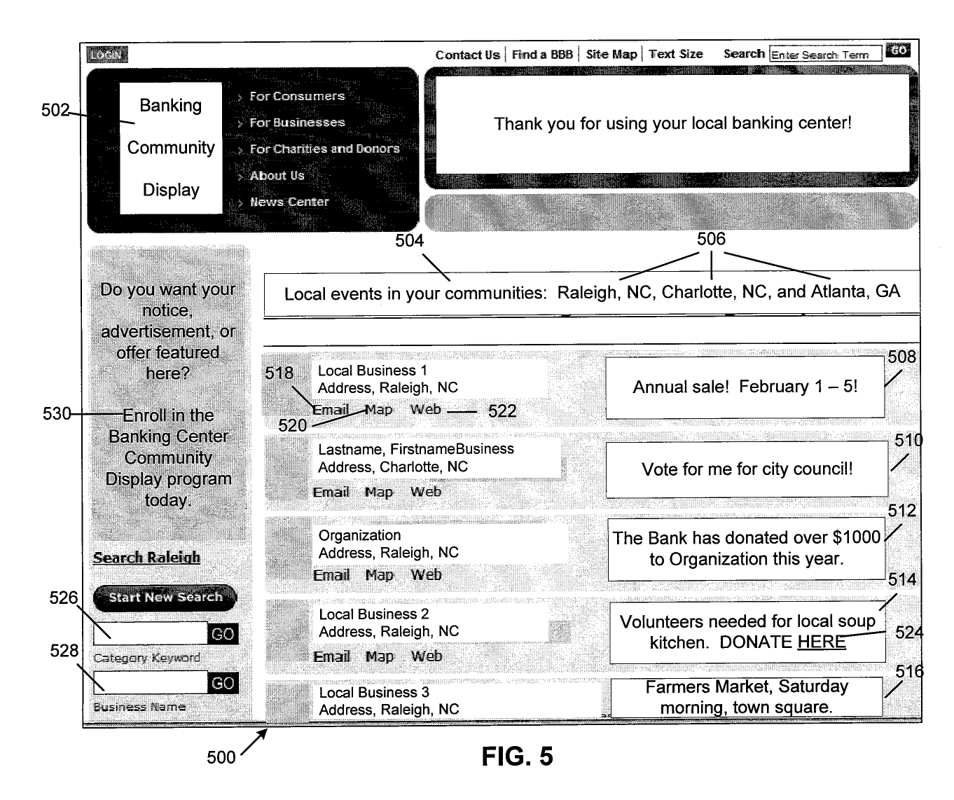

FIG. 5 is a screenshot of an embodiment of a banking center community display graphical user interface 500, in accordance with one example embodiment of the invention. The banking center community display GUI 500 is presented in a website, on an electronic display, on an ATM screen, through a computer program, or any other type of user interface and/or display. The banking center community display 502 presents content of interest to the community 504. The community 504 may include more than one geographic region 506 associated with the banking center and/or the user. The content may be an advertisement for a business 508, an announcement from the individual 510, a message from the bank 512, a notice from a group 514, or other content of interest to the local community 516. The banking center community display 502 may allow interaction with the user interface so that a user may contact the content provider, for example, via e-mail 518, view a map relating to the content 520, or be forwarded to information regarding the content elsewhere, such as on the World Wide Web 522. Other forms of interaction are possible, including allowing a user to donate directly to a nonprofit relevant to the local community 524 or allowing a user to search content by keyword 526, business name 528, or other input. The content may be provided by the bank 512 or by a user 530.

It should be understood that the bank and the banking center community display system will generally comply with any privacy laws, rules, regulations, and/or agreements when using customer information. Furthermore, in some embodiments, the banking center community display system obtains consent from customers to use their information in this way. In some embodiments, customer transaction information is used, but is done so in a way that individual transactions and the customers making those transactions remain anonymous and cannot be discerned by any other user of the banking center community display system.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable program code/instructions for implementing the specified logical function(s). It should also be noted that, in some alternative implementations, the functions noted in the block may occur out of the order noted in the figures. For example, functions repeated by two blocks shown in succession may, in fact, be executed substantially concurrently, or the functions noted in the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer executable program code/instructions.

The terminology used herein is for the purpose of describing particular embodiments only and is not intended to be limiting of the invention, unless the context clearly indicates otherwise. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components in some embodiments, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A computer-implemented method comprising:
identifying a user interface, the user interface associated with a banking center accessible to a user;
identifying a banking center community associated with the banking center;
determining content to present on the user interface based at least partially on the banking center community; and
presenting the content to the user using the user interface.

2. The computer-implemented method of claim 1, further comprising:
receiving an input from the user regarding the content; and
responding to the user about the input.

3. The computer-implemented method of claim 1, wherein the determining content to present on the user interface comprises:
determining a plurality of communications for presentation in the community; and
selecting a communication from the plurality of communications.

4. The computer-implemented method of claim 1, wherein the banking center community comprises a geographic area with which the banking center is associated.

5. The computer-implemented method of claim 4, wherein the geographic area comprises at least one of a country that the banking center is within, a state that the banking center is within, a county that the banking center is within, a municipality that the banking center is within, an electoral district that the banking center is within, a metropolitan area that the banking center is within, a facility that the banking center is associated with, a zip code that the banking center is within, or an area defined by a circle created by a pre-determined radius from the banking center.

6. The computer-implemented method of claim 1, further comprising:
identifying the user of the user interface; and
identifying a user community associated with the user,
wherein the determining content to present on the user interface is further based on the user community.

7. The computer-implemented method of claim 6, wherein the user community comprises a region associated with the user.

8. The computer-implemented method of claim 7, wherein the region associated with the user comprises at least one of a country, a state, a county, a zip code, a municipality, an electoral district, and a metropolitan region.

9. The computer-implemented method of claim 1, wherein the banking center community comprises a group of individuals associated with the banking center.

10. The computer-implemented method of claim 1, wherein the content comprises an advertisement, wherein a target audience for the audience comprises the banking center community.

11. The computer-implemented method of claim 1, wherein the banking center comprises a bank branch, and wherein the user interface comprises a display device in a lobby of the bank branch.

12. The computer-implemented method of claim 1, wherein banking center comprises an automated teller machine, and wherein the user interface comprises a display device associated with and located proximate to the automated teller machine.

13. The computer-implemented method of claim 1, wherein the banking center community is an area in which the banking center is located.

14. The computer-implemented method of claim 1, further comprising identifying a user of the user interface, and wherein the determining content comprises:
identifying a plurality of communications associated with the banking center community; and
selecting one of the plurality of communications based at least partially on the user's identity.

15. The computer-implemented method of claim 1, wherein the content comprises at least one of a message from the bank, a message from a customer, or a message from a governmental entity.

16. The computer-implemented method of claim 15, wherein the message from the bank relates to an involvement of the bank in the banking center community.

17. The computer-implemented method of claim 1, further comprising:
determining the banking center community associated with the banking center based at least partially on transaction data associated with the banking center.

18. An apparatus comprising:
a computer system;
a memory system communicably coupled to the computer system and comprising content stored therein; and
a banking center community display server application operable on the computer system, wherein the banking center community display server application is configured to:
identify a banking center community associated with a banking center;
select content from the memory system based at least partially on the banking center community; and
present the content to a user interface located at the banking center.

19. The apparatus of claim 18, wherein the banking center community display server application is further configured to:
identify a banking center community associated with a location of the banking center.

20. The apparatus of claim 18, wherein the banking center community display server application is further configured to:
identify a user community associated with a user of the user interface; and
determine the content based on the banking center community and user community.

21. The apparatus of claim 18, wherein the banking center community display server application is further configured to:
receive user input from the user interface;
select additional content from the memory system based on the user input; and
present the additional content to the user interface.

22. The apparatus of claim 18, wherein the banking center community display server application is configured to identify a banking center community associated with a banking center by determining a geographic area with which the banking center is associated.

23. The apparatus of claim 22, wherein the geographic area comprises at least one of a country that the banking center is within, a state that the banking center is within, a county that the banking center is within, a municipality that the banking center is within, an electoral district that the banking center is within, a metropolitan area that the banking center is within, a facility that the banking center is associated with, a zip code that the banking center is within, or an area defined by a circle created by a pre-determined radius from the banking center.

24. The apparatus of claim 18, wherein the banking center comprises a bank branch, and wherein the user interface comprises a display device in a lobby of the bank branch.

25. The apparatus of claim 18, wherein banking center comprises an automated teller machine, and wherein the user interface comprises a display device associated with and located proximate to the automated teller machine.

26. The apparatus of claim 18, further comprising:
a user input device configured to allow customers of the bank to provide the content stored in the memory system.

27. A non-transitory computer readable medium having computer usable program code embodied therein for providing a banking center community display, the non-transitory computer readable storage medium comprising:
computer usable program code configured to identify a user interface, the user interface associated with a banking center accessible to a user;
computer usable program code configured to determine a community, the community comprising a banking center community associated with the banking center;
computer usable program code configured to determine content based on the community; and
computer usable program code configured to present the content.

28. The computer readable storage medium of claim 27, further comprising computer usable program code configured to identify the user of the user interface, the user having a user community.

29. The computer readable storage medium of claim 28, wherein the community further comprises the user community.

30. The computer readable storage medium of claim 27, further comprising:
computer usable program code configured to receive and respond to an input from the user.

31. The computer readable storage medium of claim 27, wherein the content is provided by a bank based on an involvement of the bank in the community.

32. The computer readable storage medium of claim 27, wherein the content is provided by a customer of the bank.
